(19) United States
(12) Patent Application Publication
(10) Pub. No.: US 2009/0235345 A1
(43) Pub. Date: Sep. 17, 2009

(54) AUTHENTICATION SYSTEM, AUTHENTICATION SERVER APPARATUS, USER APPARATUS AND APPLICATION SERVER APPARATUS

(76) Inventors: Mitsuhiro OIKAWA, Kawasaki (JP); Tomochika Tomiyama, Kawasaki (JP); Tatsunoshin Kawaguchi, Kawasaki (JP)

Correspondence Address: MCDERMOTT WILL & EMERY LLP, 600 13TH STREET, N.W., WASHINGTON, DC, 20005-3096, US

(21) Appl. No.: 12/391,674

(22) Filed: Feb. 24, 2009

(30) Foreign Application Priority Data
Mar. 14, 2008 (JP) 2008-065083

(51) Int. Cl. H04L 9/32; G06F 21/00

(52) U.S. Cl. 726/7

(57) ABSTRACT

An authentication system having a user apparatus that performs authentication using first authentication data and a second authentication server that performs authentication using second authentication data is provided. The user apparatus acquires the second authentication data from a user and requests authentication of the user by sending the acquired second authentication data to the second authentication server. The second authentication server performs authentication of the user on a basis of the second authentication data received from the user apparatus and sends the user apparatus a result of the authentication and when the authentication is successful, first authentication data stored being associated with the user. The user apparatus acquires a result of authentication based on the first authentication data received from the second authentication server and performs login processing when the acquired result of the authentication based on the first authentication data indicates success.

### INCORPORATION BY REFERENCE

This application claims priority based on a Japanese patent application, No. 2008-065083 filed on Mar. 14, 2008, the entire contents of which are incorporated herein by reference.

### BACKGROUND

The present invention relates to an authentication technique that makes it easy to migrate from a conventional authentication method using a password to an authentication method that provides higher level of security and improves the convenience also.

As a result of the recent propagation of information technology (IT), various kinds of information have been computerized, being sent and received through a network. Although use of a network allows sending and receiving of information to and from a person far apart, it is exposed to the threat of masquerading of the other party. As one method of preventing masquerading of the other party, there is an authentication method using a user ID and a password. This method is used in many scenes.

However, this password authentication is not a highly safe method because there are problems such that a malicious person can know a password of another person by analogy with relatively little effort and a legitimate user may record a password on paper not to forget it in actual operation.

As advanced authentication methods for avoiding such problems, there are authentication methods using a token for generating a one-time password, authentication methods using a Smart card or a USB token, and authentication methods using biometrics such as fingerprints, voiceprints, vein or the like. In particular, biometric authentication methods are highly secure since it is difficult to imitate such a physical feature and it is also impossible to forget such a feature.

Document 1 (Japanese Unexamined Patent Application Laid-Open No. 2003-140765) discloses a password management method that places a user authentication system as a previous step to a business system using password authentication, in order to enhance security of the business system. The user authentication system authenticates fingerprint information inputted through a user terminal, and a user ID and a password corresponding to the authenticated user are sent to the business system. Thus, quite high-level of security is realized by the simpler technique that does not make a user aware of a password on the side of the business system.

In addition to strengthening of the previous step authentication, i.e. authentication of a user terminal by the biometric authentication, the Document 1 also shows a method of updating a password automatically in order to assure the security of the password authentication in the business system placed in the latter part.

However, according to the technique of the Document 1, the latter step authentication is password authentication itself. Thus, although a password is periodically updated automatically, the security of the system as a whole is not improved so much if its updating period is long. This is because a malicious user can bypass the previous step authentication if he once couples an illegal personal computer (PC) to the network, and in that case the security of the system depends on the latter step authentication. From the fact that the Document 1 takes measures that employ a more secure method than password authentication as the previous step authentication, it is possible to infer that this technique assumes that an attacker can break the latter step password authentication.

On this assumption, an attacker can attack and break the latter step authentication, and the above method is insufficient as measures for ensuring the security of the system as a whole.

On the other hand, when one tries to replace the authentication in the previous step and/or the latter step by another method of authentication than the password authentication, it is necessary to alter programs of the existing system and thus introduction of such a method is difficult.

Further, the user authentication system of the known technique employs the arrangement in which a password is automatically sent to the latter step business system. Thus, there is also a problem that automatic login is difficult if the latter step authentication is replaced by biometric authentication or the like.

In other words, it is desired that strengthening of the security levels of the previous step user authentication system and the latter step authentication of the business system to the comparable level is compatible with easiness of strengthening of the authentication without altering programs in the previous step and/or the latter step.

Further, since a need for the single sign-on (which enables login to a plurality of business systems by single authentication) is recently increasing, it is also desired to accommodate to the single sign-on that overcome the above problem and gives high-level of security.

### SUMMARY OF THE INVENTION

The disclosed system provides a method of strengthening the security level of authentication without requiring alteration of existing programs, for an authentication system that performs authentication processing using a password.

Further, the disclosed system provides a method of realizing authentication strengthening and single sign-on for a PC and one or more business systems using password authentication. In detail, the disclosed system provides a method that can be easily introduced while strengthening the security of the previous step authentication in the PC and the latter step authentication in each business system to the comparable level.

The disclosed system provides an authentication system that can prevent simple illegal access even if the previous step authentication is bypassed. This is realized by placing a high-level authentication function before the password authentication function that an existing business system has, without altering the existing business system itself

A mode of the disclosed system provides an authentication system comprising a user apparatus that performs authentication processing using first authentication data and a second authentication server apparatus that performs authentication processing using second authentication data, wherein:

the user apparatus acquires the second authentication data from a user, and requests authentication of the user by sending the acquired second authentication data to the second authentication server apparatus;

the second authentication server performs authentication processing of the user on a basis of the second authentication data received from the user apparatus, and sends the user apparatus a result of the authentication processing and, when the authentication is successful, first authentication data stored being associated with the user;

the user apparatus acquires a result of authentication processing based on the first authentication data received from the second authentication server apparatus, and performs login processing when the acquired result of the authentication processing based on the first authentication data indicates success.

Further, the authentication system is characterized in that:

the authentication system further comprises an application server apparatus;

the user apparatus stores the second authentication data acquired from the user; sends the result of the authentication processing based on the first authentication data received from the second authentication server apparatus; and receives a use request for using the application server apparatus from the user after the login processing, and sends the received use request to the application server apparatus;

the second authentication server apparatus receives the result of the authentication processing result based on the first authentication data sent to the user apparatus, from the user apparatus;

the application server apparatus sends an authentication processing request based on the use request received from the user apparatus to the user apparatus;

the user apparatus sends the stored second authentication data of the user to the application server apparatus in response to the authentication processing request received from the application server apparatus;

the application server apparatus sends the second authentication data received from the user apparatus to the second authentication server apparatus, to request authentication of the user;

the second authentication server performs authentication processing on a basis of the second authentication data received from the application server apparatus when the authentication processing result received from the user apparatus is successful, and sends the first authentication data stored being associated with the user to the application server apparatus, when the authentication processing is successful; and

the application server apparatus performs authentication processing of the user on a basis of the first authentication data received from the second authentication server apparatus.

Further, the user apparatus may perform authentication processing on a basis of the first authentication data received from the second authentication server apparatus, and acquire a result of the authentication processing.

Further, the authentication system may be arranged in such a way that:

the authentication system further comprises a first authentication server apparatus that performs authentication processing on a basis of the first authentication data;

the user apparatus sends the first authentication data received from the second authentication server apparatus to the first authentication server apparatus;

the first authentication server apparatus performs the authentication processing of the user on a basis of the first authentication data received from the user apparatus, and sends a result of the authentication processing to the user apparatus; and

the user apparatus acquires the result of the authentication processing.

Further, as an example, the first authentication data is a password, and the second authentication data is biometric data.

Further, another mode of the disclosed system provides an authentication system comprising a high-level authentication client program, a high-level authentication agent program, a high-level authentication server apparatus, and a password management server apparatus, wherein; the high-level authentication client program holds high-level authentication information used at the time of first authentication of OS; single sign-on covering OS login is performed by reusing the held high-level authentication information at the time of using an application; and update of passwords and management of authentication statuses are performed without requiring processing by users.

According to the above mode, it is not necessary to alter programs used in the existing business system, and migration to high-level authentication can be realized by introducing other programs as additional components to the existing system. Thus, the introduction can be performed very easily.

Further, the disclosed system makes an authentication method in a latter step more secure, and higher security can be ensured in comparison with the existing system even when authentication in a previous step is bypassed.

In addition, by repeatedly (for example, periodically) updating a password used for logging in to a business system in the latter step into a random value that does not require input by the user, it is possible to give resistance against attacks by internal illegal persons.

Further, by incorporating the function of single sign-on, a user can use a plurality of business applications by performing authentication operation only once. Thus, convenience also is improved.

Further, for realizing the single sign-on, it is necessary to record somewhere a password used for automatic input of password. However, it is not necessary to record the password constantly in the user terminal and the password management server apparatus. As for the high-level authentication server apparatus in which the password should be recorded constantly, the password is periodically updated into a password unknown to the user himself. Thus, it is possible to keep the security.

Further, by making a password of OS and a password of each AP common, it is possible to reduce data size required for managing passwords in the high-level authentication server apparatus.

According to the teaching herein, authentication of PC in a previous step and authentication of each business system in a latter step can be strengthen to the same degree of security. And strengthening of authentication and single sign-on can be realized by a method that can be easily introduced into a PC and a business system having password authentication.

In addition it is possible to obtain effects such as improvement of resistance to attack by an internal illegal person, improvement of user convenience, improvement of security in realizing single sign-on, and promotion of efficiency of data held in password management.

These and other benefits are described throughout the present specification. A further understanding of the nature and advantages of the invention may be realized by reference to the remaining portions of the specification and the attached drawings.

### BRIEF DESCRIPTION OF THE DRAWINGS

FIG. 1 is a diagram showing an example of a system configuration of an embodiment;

FIG. 2 is a diagram showing an example of a hardware configuration of each of a user apparatus, an application server apparatus, an authentication server apparatus, a high-level authentication server apparatus and a password management server apparatus;

FIG. 3 is a diagram showing an example of a software configuration of the user apparatus;

FIG. 4 is a diagram showing an example of a software configuration of the application server apparatus;

FIG. 5 is a diagram showing an example of a software configuration of the authentication server apparatus;

FIG. 6 is a diagram showing an example of a software configuration of the high-level authentication server apparatus;

FIG. 7 is a diagram showing an example of a software configuration of the password management server apparatus;

FIG. 8 is a diagram showing an example of an outlined flow of authentication processing in a system to which the present embodiment is not applied;

FIG. 9 is a diagram showing an example of an outlined flow of authentication processing in a system to which the present embodiment is applied;

FIG. 10 is a diagram showing an example of an outlined flow of password update processing in the system to which the present embodiment is applied;

FIG. 11 is a diagram showing an example of a detailed flow of login processing of the user apparatus of the present embodiment;

FIG. 12 is a diagram showing an example of a detailed flow of access processing of the application server apparatus of the present embodiment; and

FIG. 13 is a diagram showing an example of a detailed flow of processing of updating a password managed by each apparatus of the present embodiment.

### DETAILED DESCRIPTION OF THE EMBODIMENTS

Now, examples will be described referring to the drawings. In the drawings described in the following, like numerals refer to like parts or components. These examples do not limit the present invention.

### Embodiment 1

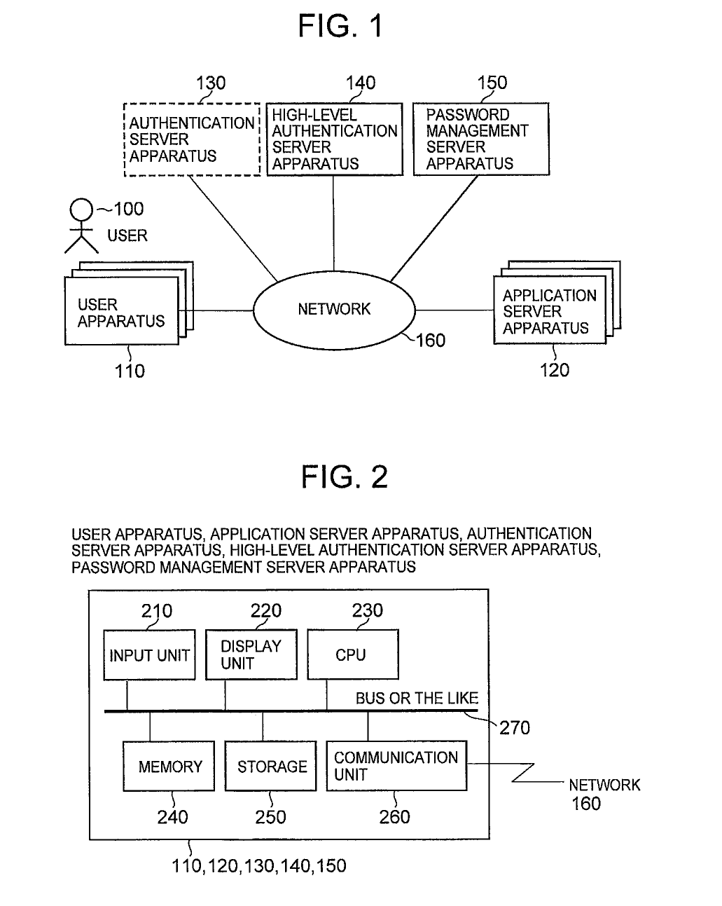

FIG. 1 is a diagram showing a system configuration of the present embodiment.

In addition to a conventional system comprising: a user apparatus 110 used by a user 100; and an application server apparatus 120 used for some work by the user 100 through the user apparatus 110, with the apparatuses 110 and 120 being coupled with each other through a network 160, a system according to the present embodiment further comprises: a high-level authentication server apparatus 140 for verifying high-level authentication information; and a password management server apparatus 150 for performing automatic update of a password, where the apparatuses 140 and 150 are coupled to the network 160.

FIG. 2 is a diagram showing a hardware configuration of each apparatus.

Each of the user apparatus 110, the application server apparatus 120, an authentication server apparatus 130 corresponding to a first authentication server apparatus, the high-level authentication server apparatus 140 corresponding to a second authentication server apparatus, and the password management server apparatus 150 is implemented by a computer comprising: an input unit 210, a display unit 220, a CPU 230, a memory 240, a secondary storage 250, a communication unit 260, and a bus 270 that couples components with one another.

The input unit 210 is operated by a user of the apparatus in order to input data, instructions and the like. The input unit 210 comprises: a keyboard; a mouse; a device (for example, a Smart card reader or a biometric data reader) for inputting high-level authentication information; and the like.

The display unit 220 is used for displaying a message or the like to the user of the apparatus, and comprises a CRT, a liquid crystal display, or the like.

The CPU 230 executes programs stored in the memory 240 or the secondary storage 250 to control each component of the apparatus or perform various kinds of processing such that the below-described various kinds of processing are realized.

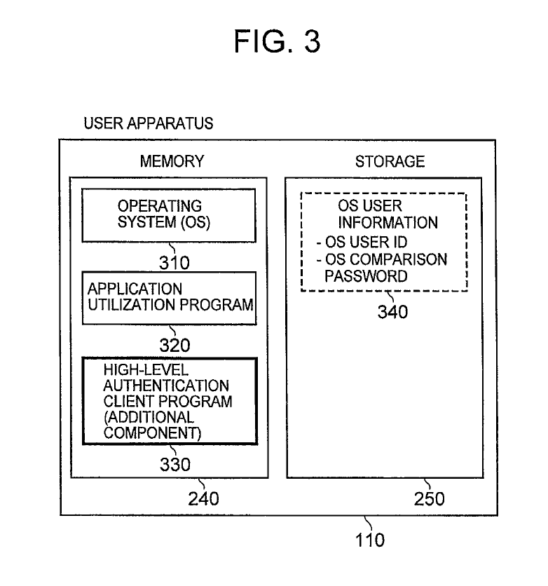

The memory 240 temporarily stores programs such as those shown in FIGS. 3-7 and data required for processing. These programs and data are loaded from the secondary storage 250 into the memory 240. In many cases, the memory 240 is implemented by a volatile storage medium such as RAM. The secondary storage (hereinafter, simply referred to as storage) 250 is used for permanently storing programs to be executed by the CPU 230 and data to be used, and is implemented by a nonvolatile storage medium such as a hard disk. The communication unit 260 is a physical interface required for sending and receiving data to and from another apparatus through the network 160, and is implemented by. a LAN board, a wireless LAN card, or the like.

Now, a configuration and functions of software for each apparatus will be described. Programs stored in each apparatus are read from the storage in that apparatus and executed by the CPU 230 so as to realize respective functions of the programs. For the sake of convenience, however, sometimes each program may be expressed as an executing subject in the following description.

FIG. 3 is a diagram showing a software configuration of the user apparatus 110. The memory 240 is loaded with an operating system (hereinafter, referred to as OS) 310 and an application utilization program 320. Further, the storage 250 stores data such as OS user information 340. When the authentication server apparatus 130 is used, the data in question are stored in the authentication server apparatus 130, and thus the data may not exist in the storage 250 of the user apparatus 110.

In addition to the above, the arrangement of the present embodiment is characterized in that the memory 240 is further loaded with a high-level authentication client program 330.

In FIG. 3, the OS 310 is a program for realizing functions such as file management, process management and device management in order to control the apparatus as a whole.

The application utilization program 320 is a program on the client side that is required for using an application program (hereinafter, referred to as AP) 420 in the application server apparatus 120. For example, in the case where the AP 420 is a Web system, a Web browser corresponds to the application utilization program 320. In the case where the AP 420 is a client-server type application, a client program for that application corresponds to the application utilization program 320.

The high-level authentication client program 330 is a program having a function for using high-level authentication for logging in to the OS 310 and a single sign-on function for automatically inputting high-level authentication information when input of the high-level authentication information is requested from the application utilization program 320.

Here, the high-level authentication means an authentication method that is seemed to be more secure than an authentication method using a password, such as an authentication method using a tangible object such as an a Smart or a USB token or an authentication method using a biometric characteristic such as fingerprints, voiceprints, vein or the like.

The OS user information 340 is information that is needed for logging in to the OS and is managed for each user. For example, a user ID for OS, a comparison password, and the like correspond to the OS user information 340. It is desired that the comparison password is recorded as a hash value or an encrypted value.

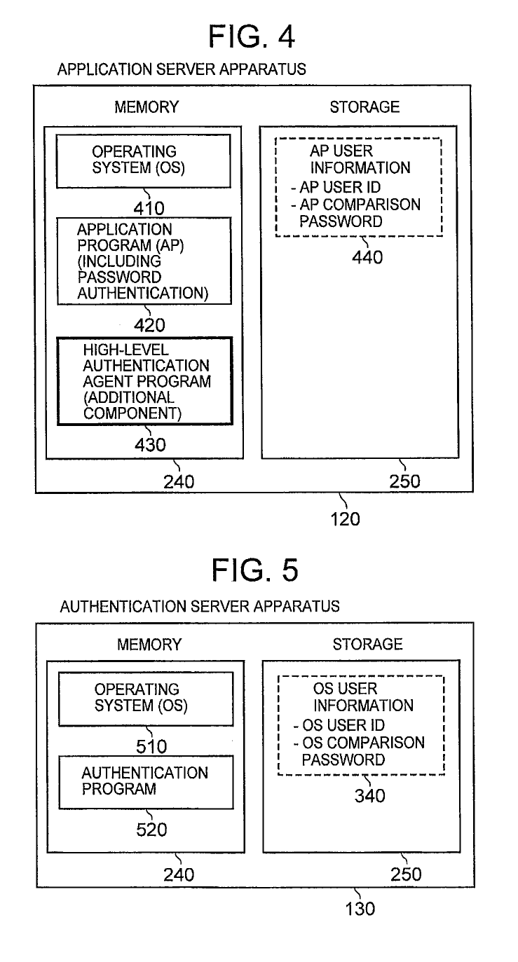

FIG. 4 is a diagram showing a software configuration of the application server apparatus 120. The memory 240 is loaded with an OS 410 and an AP 420. Further, the storage 250 stores data such as AP user information 440.

In addition to the above, the arrangement of the present embodiment is characterized in that the memory 240 is further loaded with a high-level authentication agent program 430.

In FIG. 4, the OS 410 is a program for realizing functions such as file management, process management and device management in order to control the apparatus as a whole.

The AP 420 is various business programs used as an existing system. For example, various Web server programs or server programs of a client-server type system, such as an ERP program, an accounting program, a document management program and the like, correspond to the AP 420. Further, it is assumed that the AP 420 as the existing system is equipped with a password authentication function also. Furthermore, it is assumed that the AP 420 is provided with server authentication and communication encryption functions according to Secure Socket Layer (SSL), Transport Layer Security (TLS), or the like, as measures against replay attack on communication with the user apparatus.

The high-level authentication agent program 430 is a program for changing authentication required for accessing the AP 420 into high-level authentication. This program is executed before the AP 420 is executed. For example, a filter program or a program that is realized by hooking data sent or received in a lower layer may be mentioned as the high-level authentication agent program 430.

The AP user information 440 is information that is required for accessing the AP and managed for each user. For example, a user ID for AP and a comparison password for accessing the AP correspond to the AP user information 440. The comparison password is recorded as a hash value or an encrypted value.

FIG. 5 is a diagram showing a software configuration of the authentication server apparatus 130.

Necessity of the authentication server apparatus 130 depends on the form of implementing authentication of login to the OS 310 of the user apparatus 110. That is to say, the authentication server apparatus 130 is not necessary if authentication of login to a user apparatus 110 is performed on a user apparatus on the basis of registered user information (This case is referred to as local authentication). On the other hand, in the case where there are a plurality of user apparatuses and, at the time of login from any user apparatus using the same user information, authentication is performed on the basis of user information managed within a domain whose range is previously defined for example by addresses (This case is referred to as authentication within domain), the authentication server apparatus 130 that functions effectively within that domain is necessary.

The memory 240 of the authentication server apparatus 130 is loaded with an OS 510 and an authentication program 520. Further, the storage 250 stores data such as OS user information 340.

In FIG. 5, the OS 510 is a program for realizing functions such as file management, process management and device management in order to control the apparatus as a whole.

The authentication program 520 is a program that performs password verification to judge whether a user ID and a password of a user trying to log in to the user apparatus 110 are valid, on the basis of a request from the OS 310 of the user apparatus 110. The authentication program 520 returns the result of password verification to the user apparatus. At the time of verification, the authentication program 520 uses the OS user information 340 stored in the authentication server apparatus 130.

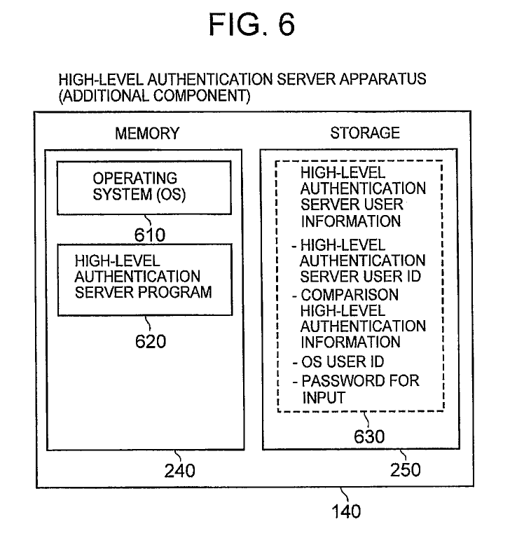

FIG. 6 is a diagram showing a software configuration of the high-level authentication server apparatus 140. The memory 240 is loaded with an OS 610 and a high-level authentication server program 620. Further, the storage 250 stores data such as high-level authentication server user information 630.

In FIG. 6, the OS 610 is a program for realizing functions such as file management, process management and device management in order to control the apparatus as a whole.

The high-level authentication server program 620 is a program that performs verification of high-level authentication information to judge whether the high-level authentication relating to a user trying to log in to the user apparatus 110 or to access the AP 420 of the application server apparatus 120 is valid, on the basis of a request from the high-level authentication client program 330 in the user apparatus 110 or the high-level authentication agent program 430 in the application server apparatus 120. The high-level authentication server program 620 returns the result and a user ID and a password required for login or access to the sender of the request.

At the time of verification, the high-level authentication server program 620 uses the high-level authentication server user information 630 stored in the high-level authentication server apparatus 140. Further, the high-level authentication server program 620 has a function of managing an authentication status. In detail, in the case where authentication of a user is successful, the authentication of the user is managed as “authenticated”. And, in the case where the user logs off from each system or a predetermined time has elapsed from the last access, the authentication status is managed as “unauthenticated”. Further, it is assumed that the high-level authentication server program 620 is provided with server authentication and communication encryption functions according to Secure Socket Layer (SSL), Transport Layer Security (TLS), or the like, as measures against replay attack on communication with the user apparatus and the application server apparatus.

The high-level authentication server user information 630 is information in which high-level authentication information, passwords needed after success of high-level authentication information, and the like are managed for each user. For example, a user ID for the high-level authentication server, high-level authentication information used for comparison at the time of high-level authentication, a user ID to be inputted at the time of login to the OS of the user apparatus 110, a password used for logging in to OS or for accessing each AP, and the like correspond to the high-level authentication server user information 630. The password is managed in an encrypted state or a state that access to the password is limited, so that the other users than the user of the password can not access the password.

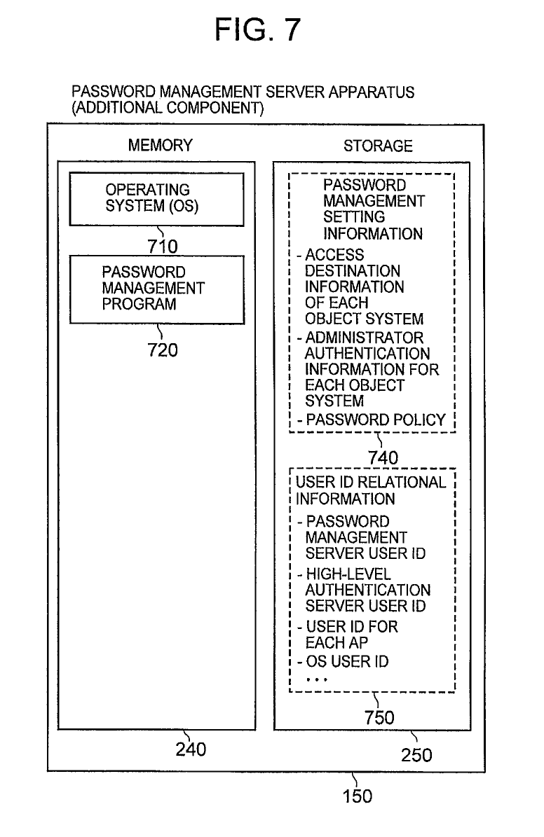

FIG. 7 is a diagram showing a software configuration of the password management server apparatus 150. The memory 240 is loaded with an OS 710 and a password management program 720. Further, the storage 250 stores data such as password management setting information 740 and user ID relational information 750.

In FIG. 7, the OS 710 is a program for realizing functions such as file management, process management and device management in order to control the apparatus as a whole.

The password management program 720 is a program for collectively updating passwords managed by a plurality of programs (OSs and APs). Passwords for each program are periodically updated by execution of the password management program 720.

Further, the password management program 720 has an interface through which a system administrator can force a password to be reset, and also has a function that can update a password manually at need. At the time of updating a password, update is performed on the basis of the password management setting information 740 and the user ID relational information 750. Further, the password management program 720 has also a function of generating a password automatically in conformity with the password policy, by using random numbers, for example.

The password management setting information 740 is information that records pieces of information required for collectively updating passwords of a plurality of programs. For example, access destination information (such as a URL) of each program as an object of password update, authentication information (such as an administrator user ID and an administrator password) for an administrator who has authority to rewrite a password of each object program, password policy (which defines the number of characters and kinds of characters required for a password, for example), and the like correspond to the password management setting information 740.

The user ID relational information 750 is information indicating, for each system, a password of which user ID should be updated if a password of a certain user is to be updated. The user ID relational information is managed for each user. For example, a password management server user ID managed by the password management program 720 in the password management server apparatus 150, a user ID for the high-level authentication server apparatus using a password in the present embodiment, a user ID for each AP, a user ID for each OS, and the like correspond to the user ID relational information 750.

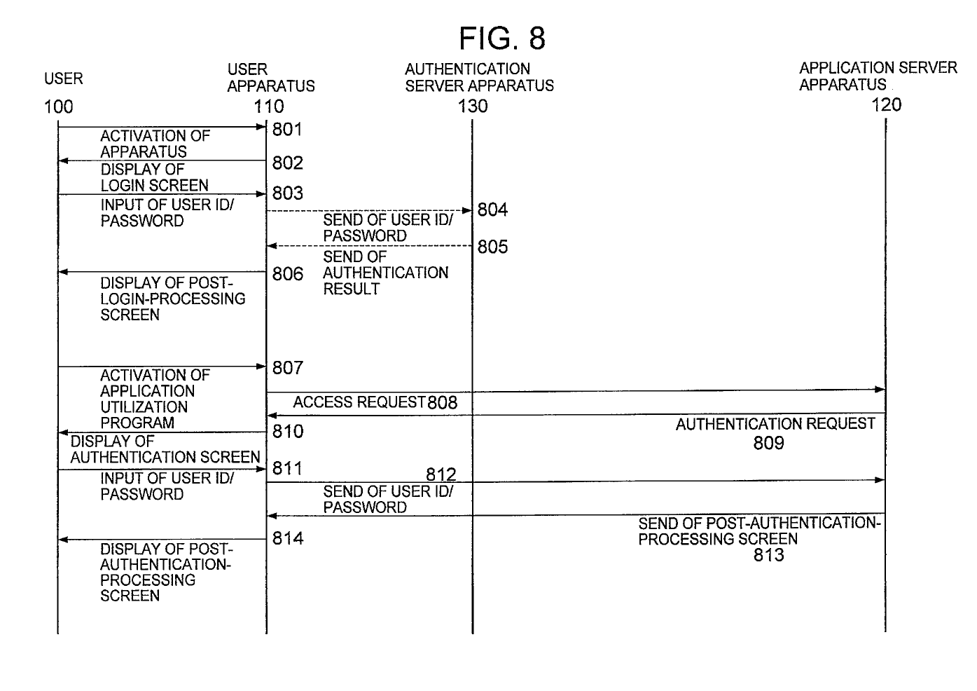

FIG. 8 is a diagram showing an outlined flow of authentication processing before application of the present embodiment.

A procedure performed between the user 100, the user apparatus 110, the authentication server apparatus 130 and the application server apparatus 120 will be described. In this procedure, the user 100 logs in to the OS of the user apparatus 110, and accesses the AP in the application server apparatus 120 through the user apparatus 110.

In FIG. 8, the user 110 activates the user apparatus 110 (Step 801, or S801 in the way of the following description). The user apparatus 110 activates the OS, to display to the user 100 a login screen for logging in to the OS (S802). Here, a screen for inputting an OS user ID and a password is displayed.

Next, the user 100 inputs an OS user ID and a password (S803). The user apparatus 110 performs authentication by comparing the inputted password of the OS user ID and a comparison password of the user ID in question. When both passwords coincide, the user is judged to be a valid user, and his login is permitted. In the case where this authentication is performed locally, the comparison password is recorded as OS user information in the user apparatus 110 in question, and thus the authentication is performed by referring to the OS user information. Based on the authentication result, permission or rejection of the user's login is determined.

In the case where the authentication is performed within the domain, the comparison password is recorded in the authentication server apparatus 130. Thus, the user ID and password inputted by the user 100 are sent to the authentication server apparatus 130 (S804). The authentication server apparatus 130 performs authentication by comparing the received user ID and password with the OS user information recorded in the authentication server apparatus 130. Then, the authentication server apparatus 130 returns the authentication result to the user apparatus 110 (S805).

Based on the received authentication result, the user apparatus 110 determines permission or rejection of the user's login. Subsequently, the user apparatus 110 displays a post-login-processing screen, depending on the result of login permission or rejection (S806). In the case where the login has been permitted, programs in the user apparatus 110 become available to the user 100, and thus the user 100 activates the application utilization program (S807). When the activation is started, the application utilization program in the user apparatus 110 sends an access request to the AP in the application server apparatus 120 (S808). The AP in the application server apparatus 120 receives the access request, and makes a request to the user apparatus 110 for authentication information (S809). Here, a user ID and password for the AP are requested.

In response to the request for authentication information, the application utilization program in the user apparatus 110 displays to the user 100 a screen for inputting an AP user ID and password (S810). The user inputs an AP user ID and password (S811), and then the user apparatus 110 sends these pieces of information to the AP in the application server apparatus 120 (S812).

The application server apparatus 120 performs authentication by comparing the received AP user ID and password with the comparison password of the user ID in question. If both passwords coincide, the user is judged to be a valid user, and his access is permitted. Since the comparison password is recorded as AP user information in the application server apparatus 120, the authentication is performed by referring to the AP user information. Then, based on the authentication result, permission or rejection of the user's access is determined. Depending on the result of access permission or rejection, the application server apparatus 120 sends a post-authentication-processing screen (S813). And, the user apparatus 110 displays the received post-authentication-processing screen to the user 100 (S814).

Hereinabove, one form of authentication flow before application of the present embodiment has been described. The present embodiment aims for strengthening of authentication and improvement of convenience without altering the programs of the system.

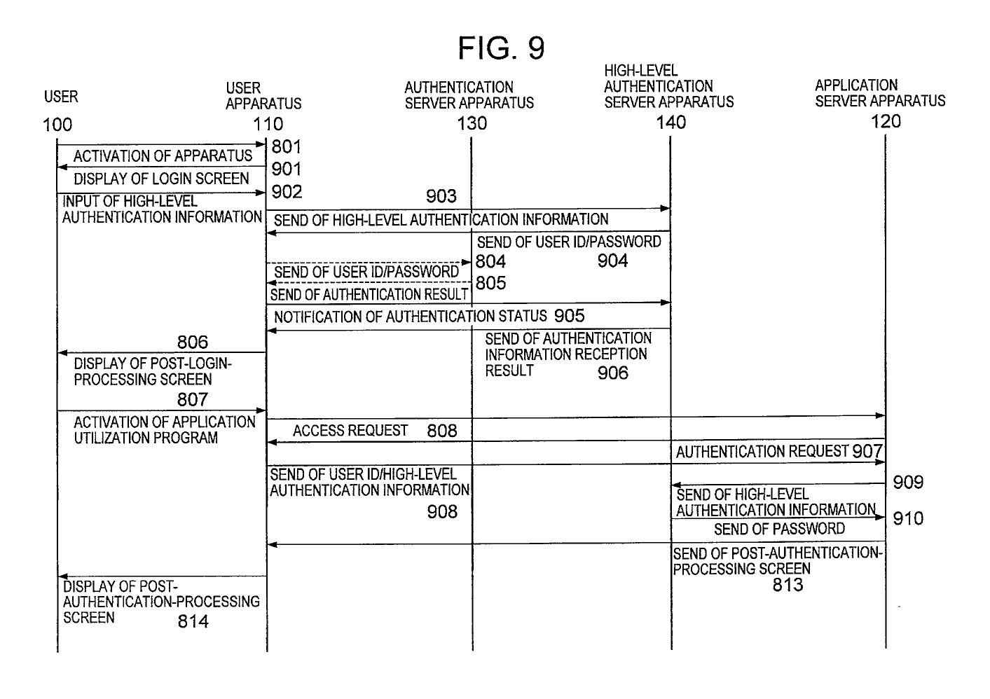

FIG. 9 is a diagram showing an outlined flow of authentication processing after application of the present embodiment.

A procedure performed between the user 100, the authentication server apparatus 130, the high-level authentication server apparatus 140 and the application server apparatus 120 will be described. In this procedure, the user 100 logs in to the OS of the user apparatus 110, and access the AP in the application server apparatus 120 through the user apparatus 110. In the figure, the same processing steps as those in FIG. 8 have the same step numbers, respectively.

The processing flow in FIG. 9 is realized by adding the high-level authentication client program 330 to the user apparatus 110, and the high-level authentication agent program 430 to the application server apparatus 120, and by adding the high-level authentication server apparatus 140 to the system.

In FIG. 9, the user activates the user apparatus 110 (S801). The user apparatus 110 activates the OS, to display to the user 100 a login screen for logging in to the OS (S901). Here, a screen for inputting high-level authentication information is displayed. Next, the user 100 inputs high-level authentication information (S902). The user apparatus 110 sends the inputted high-level authentication information to the high-level authentication server apparatus 140 (S903). Further, the high-level authentication information inputted here is held on the memory of the user apparatus 110. The high-level authentication server apparatus 140 performs authentication of the user by comparing the received high-level authentication information with comparison high-level authentication information in the high-level authentication server user information recorded in the high-level authentication server apparatus 140 itself Then, the high-level authentication server apparatus 140 sends the authentication result to the user apparatus 110 (S904). If the authentication is successful, an OS user ID and password for logging in to the OS of the user apparatus are sent as the authentication result. The user apparatus 110 performs authentication by comparing the received password of the OS user ID with the comparison password of the user ID in question. When both passwords coincide, the user is judged to be a valid user, and his login is permitted. In the case where this authentication is performed locally, the comparison password is recorded as OS user information in the user apparatus 110, and thus the authentication is performed by referring to the OS user information. Based on the authentication result, permission or rejection of the user's login is determined.

In the case where the authentication is performed within the domain, the comparison password is recorded in the authentication server apparatus 130. Thus, a user ID and a password inputted by the user 100 are sent to the authentication server apparatus 130 (S804). The authentication server apparatus 130 performs authentication by comparing the received user ID and password with the OS user information recorded in the authentication server apparatus 130, and returns the authentication result to the user apparatus 110 (S805).

Based on the received authentication result, the user apparatus 110 determines permission of rejection of the user's login. Subsequently, in the case where the login is permitted, the user apparatus 110 notifies the high-level authentication server apparatus 140 of authentication status information indicating that the user 100 has been authenticated as a result of user's valid login (S905). The high-level authentication server apparatus 140 receives the authentication status notification and changes the authentication status of the user 100 into the status of “authenticated”. Then, the high-level authentication server apparatus 140 returns the result of receiving the authentication status notification to the user apparatus 110 (S905).

Next, depending on the result of login permission or rejection, the user apparatus 110 displays a post-login-processing screen to the user 100 (S806). In the case where the login has been permitted, programs in the user apparatus 110 become available to the user 100, and thus the user 100 activates the application utilization program (S807). When the activation is started, the application utilization program in the user apparatus 110 sends an access request to the AP in the application server apparatus 120 (S808). The AP in the application server apparatus 120 receives the access request, and makes a request to the user apparatus 110 for authentication information (S907). Here, high-level authentication information is requested.

In response to the request for authentication information, the application utilization program in the user apparatus 110 performs processing for displaying to the user 100 a screen for inputting. high-level authentication information. In the course of this processing, the high-level authentication client program detects that it is an authentication screen for the AP that has made the authentication request, and the high-level authentication client program performs processing of inputting the user ID for the AP and the high-level authentication information held on the memory without awaiting input by the user, and sends these pieces of information to the application server apparatus 120 (S908). Here, it is assumed that the user ID for the AP (i.e. AP user ID) is previously set in the high-level authentication client program, being associated with features of the authentication screen for the AP (for example, a combination of any one or more of window title, window size, URL, input field attribute, and bit map information displayed in the window).

The high-level authentication agent program 430 in the application server apparatus 120 sends the received high-level authentication information to the high-level authentication server apparatus 130 (S909). The high-level authentication server apparatus 130 performs authentication of the user by comparing the received high-level authentication information with the comparison high-level authentication information in the high-level authentication server user information. At the same time, the high-level authentication agent program 430 examines whether the authentication status of the user is “authenticated”. If the status is “authenticated”, it is judged that the authentication is successful, and the authentication result is sent to the application server apparatus 120 (S910). In the case of successful authentication, an AP password (i.e. a password for the AP) for accessing the AP in the application server apparatus 120 is sent to the AP.

The high-level authentication agent program 430 in the application server apparatus 120 delivers the received AP password and the AP user ID received from the user apparatus 110 to the AP within the application server apparatus 120. And, the high-level authentication agent program 430 performs authentication by comparing the AP user ID and password with the comparison password of the user ID. When both passwords coincide, the user is judged to be a valid user and permitted to access the AP. The comparison password is recorded as AP user information in the application server apparatus 120, and thus the authentication is performed by referring to the AP user information. Based on the authentication result, permission or rejection of user's access is determined. Depending on the result of access permission or rejection, the high-level authentication agent program 430 in the application server apparatus 120 sends a post-authentication-processing screen to the user apparatus 110 (S813). And, the user apparatus 110 displays the received post-authentication-processing screen to the user 100 (S814).

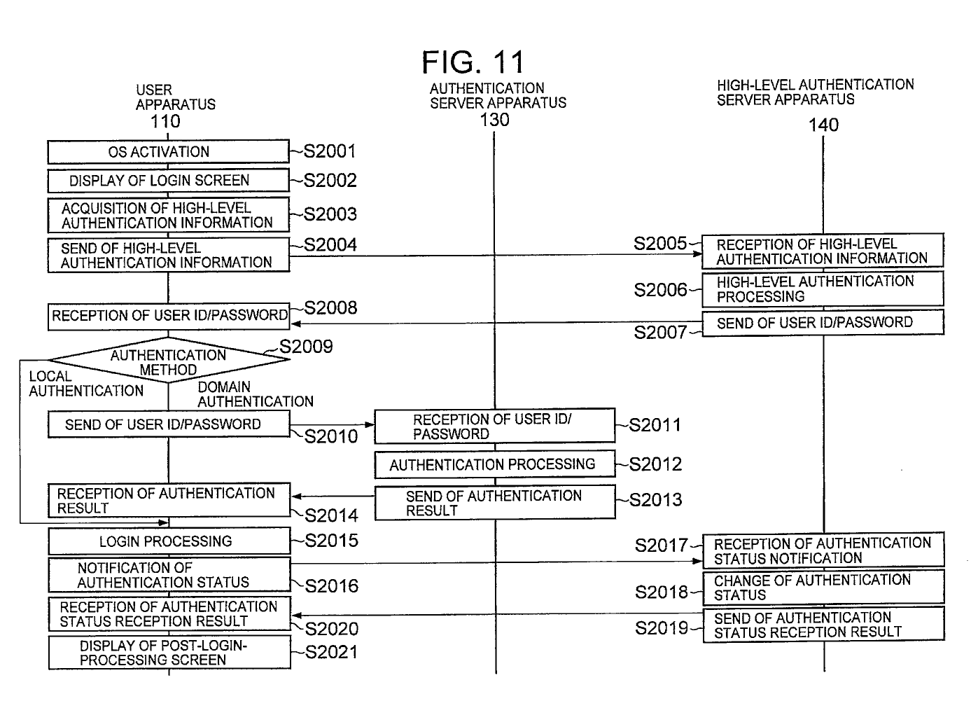

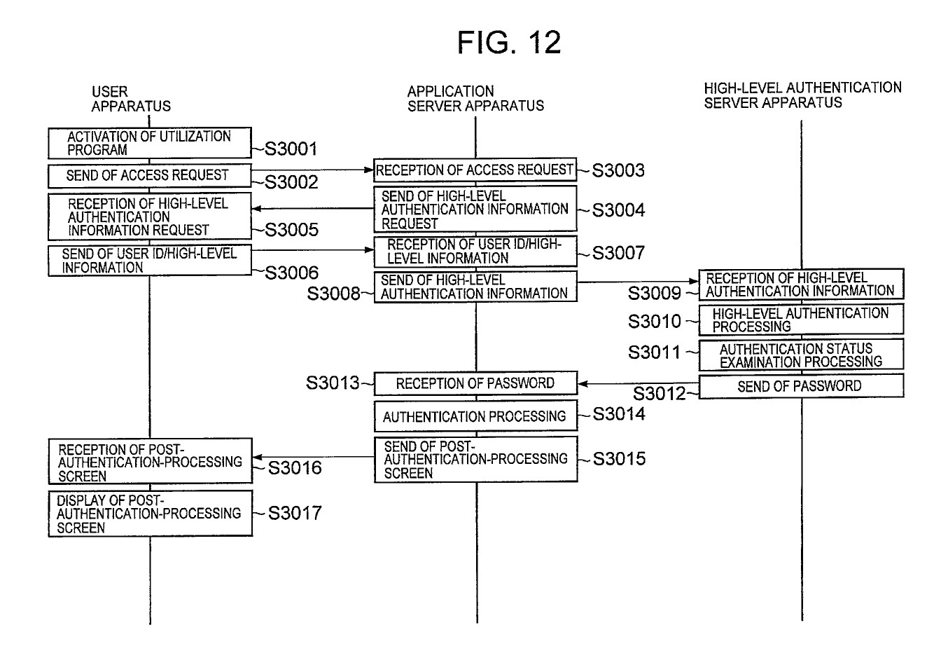

Hereinabove, an example of the authentication processing flow in the system of the present embodiment has been described. Thus, without altering the existing system, it is possible to realize strengthening of authentication on the side of the user apparatus 110, single sign-on, strengthening of authentication on the side of the application server apparatus 120, and prevention of bypassing through network. More details of the sequence shown in FIG. 9 will be described referring to FIGS. 11 and 12.

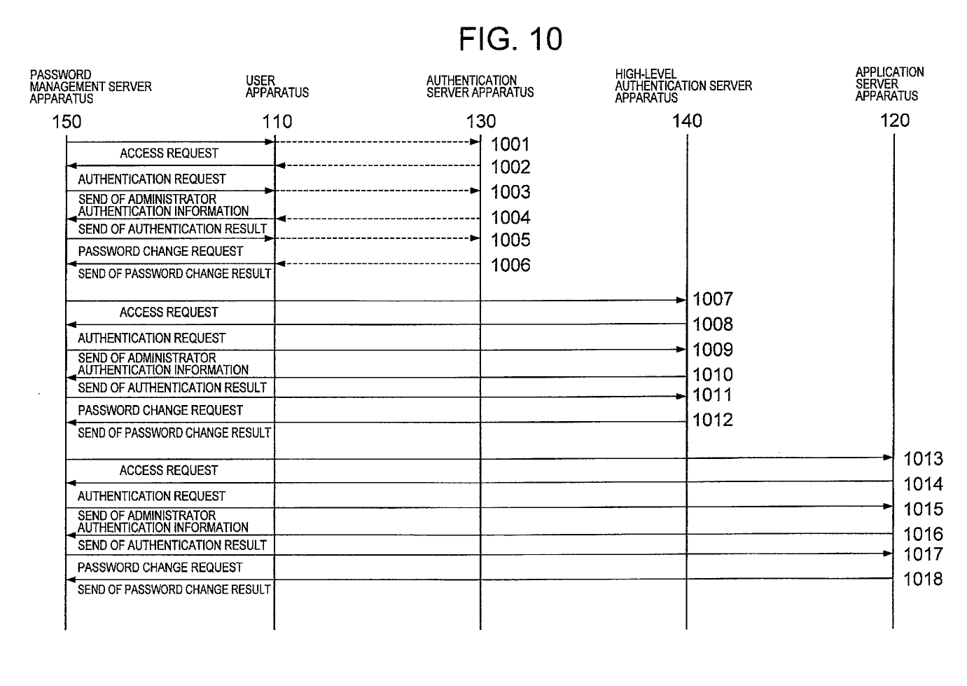

FIG. 10 is a diagram showing an example of an outlined flow of password update processing in the system of the present embodiment.

A procedure performed between the password. management server apparatus 150, the user apparatus 110 or the authentication server apparatus 130, the high-level authentication server apparatus 140, and the application server apparatus 120 will be described. In this procedure, the password management server apparatus 150 collectively (and, for example, periodically) updates passwords concerning the respective apparatuses as objects of password updating.

The processing shown in FIG. 10 is realized by adding the high-level authentication server apparatus 140 and the password management server apparatus 150 to the conventional configuration. Further, it is assumed that each apparatus managing passwords has an interface for updating a password remotely from another apparatus, and that password update requires authentication by means of authentication information for the administrator, for each system.

In FIG. 10, the password management server apparatus 150 performs password update processing repeatedly (for example, at intervals of a certain period) and independently of the flow shown in FIG. 9. In the present embodiment, when the update processing is started, a password for each user as an object of password updating is generated by using random numbers, or the like.

Subsequently, the password management server apparatus 150 sends an access request for password update to the user apparatus 110 or the authentication server apparatus 130, which is an apparatus that records comparison password for OS, as one of apparatuses as objects of password updating (S1001). When the password updating object apparatus (i.e. the user apparatus 110 or the authentication server apparatus 130) receives the access request, the password updating object apparatus make a request to the password authentication server apparatus 150 for authentication information (S1002).

In response to the request for authentication information, the password management server apparatus 150 sends authentication information for the administrator (i.e. administrator authentication information) to the password updating object apparatus (S1003). Receiving the administrator authentication information, the password updating object apparatus confirms that the received information is authentication information for a user who has authority to update password, and sends the authentication result to the password management server apparatus 150 (S1004).

Receiving the authentication result, the password management server apparatus 150 sends the user ID of the user whose password is to be updated and the password that has been previously generated automatically to the password updating object apparatus (S1005). At that time, in the case where user IDs and passwords of a plurality of users are to be updated, all pieces of information of the plurality of users are sent at once, or a similar process is repeated to the number of users. The password updating object apparatus received the user ID and password of the user, performs the password update processing, and sends the result to the password management server apparatus 150 (S1006).

Thus, the password update processing concerning the user apparatus 110 or the authentication server apparatus 130 as an apparatus that records comparison password for OS is finished. Also, in the case where the high-level authentication server apparatus 140 or each application server apparatus 120 is a password updating object apparatus, similar processing (S1007-S1012, S1013-S1018) is repeated until the passwords of all the systems as objects of password updating are updated.

At that time, as the updated password for each apparatus, the password generated in the beginning of the update processing is used. That is to say, the common password is used. Further, it does not matter in what order password updating object apparatuses are accessed at the time of password updating.

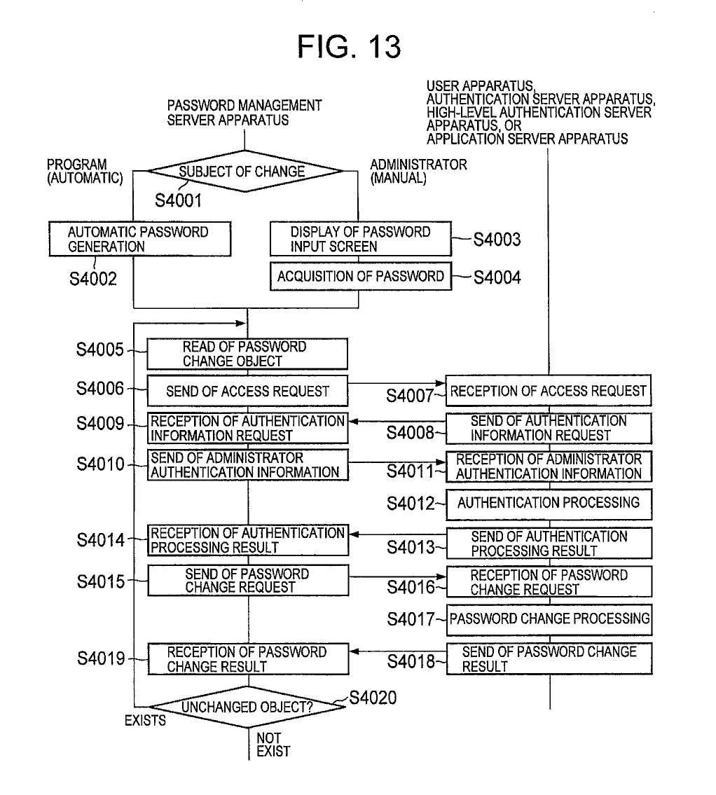

Hereinabove, an example of password update processing in the system to which the present embodiment is applied has been described. Combination of the processing shown in FIG. 9 and the processing shown in FIG. 10 can more strengthen measures against bypassing of the authentication function. Further, when a password for OS and a password for each AP are made common, the data size required for password management can be reduced. Details of the processing shown in FIG. 10 will be described referring to FIG. 13.

As described above, the present embodiment can improve resistance to illegal access in the case where authentication on the side of the user apparatus 110 or the application server apparatus 120 is strengthened without altering the conventional system.

FIGS. 11 and 12 are diagrams showing examples of detailed processing flow for the processing shown in FIG. 9. FIG. 11 shows a detailed flow concerning the login processing part of the user apparatus 110 of the present embodiment, and FIG. 12 a detailed flow concerning the access processing part of the application server apparatus 120 of the present embodiment. In the following description, each corresponding processing step in FIG. 9 will be mentioned in parallel.

In FIG. 11, owing to apparatus activation operation by the user 100, the OS 310 in the user apparatus 110 is activated. Further, it is assumed that the high-level authentication client program 330 is also activated immediately after the activation of the OS (S2001, S801).

The OS 310 of the user apparatus 110 makes a request to the user 100 for input of the OS user ID and password as information required for login. The request is detected by the high-level authentication client program 330, and then the high-level authentication client program 330 displays a login screen that requests the user 100 to input high-level authentication information instead of the OS user ID and password. Further, in the screen, a column is displayed for designating a form of OS login authentication, i.e. either local authentication or authentication in domain (S2002, S901).

Following the display of the login screen, the user 100 inputs his high-level authentication information and a form of OS login authentication. Then, the high-level authentication client program 330 of the user apparatus 110 acquires the high-level authentication information through the input unit of the user apparatus. Further, it is assumed that the high-level authentication information inputted at this point is held in the memory range managed by the high-level authentication client program 330 in the user apparatus 110. The high-level authentication information held in the memory at this point is erased from the memory at the time the OS of the user apparatus 110 is logged off or the power of the user apparatus 110 is turned off (S2003, S902).

The high-level authentication client program 330 of the user apparatus 110 sends a message including the high-level authentication information acquired in S2003 to the high-level authentication server apparatus 140. Further, the message in question includes an identifier that indicates OS login authentication, so that it can be distinguished from authentication at the time of accessing an AP (S2004, S903).

The high-level authentication server program 620 of the high-level authentication server apparatus 140 receives the message including the high-level authentication information, which is sent from the user apparatus 110 in S2004 (S2005, S903).

The high-level authentication server program 620 of the high-level authentication server apparatus 140 performs authentication of the user by using the high-level authentication information received in S2005 and the comparison high-level authentication information in the high-level authentication server user information 630 recorded in the high-level authentication server apparatus 140 itself (S2006, S904).

The high-level authentication server program 620 of the high-level authentication server apparatus 140 receives the result of the authentication in S2006, and sends a message including the authentication result to the user apparatus 110. In the case where the authentication of the user is successful, the message is made to include the OS user ID and the input password (i.e., password for input) of the user, which are recorded as the high-level authentication server user information 630. In addition, a session ID required for the authentication status notification processing is generated by random numbers, and the message in question is made to include that session ID also. Further, the session ID is held in the memory of the high-level authentication server apparatus 140, being associated with the information on the user authenticated in S2006 (S2007, S904).

The high-level authentication client program 330 of the user apparatus 110 receives the authentication result sent in S2007. If the authentication result received in this step indicates failure, the high-level authentication client program 330 displays the failure of the authentication to the user 100, and the processing returns to S2002. On the other hand, if the authentication result is successful, the session ID included in the message is kept in the memory range managed by the high-level authentication client program 330 (S2008, S904).

The high-level authentication client program 330 of the user apparatus 110 delivers the OS user ID and the input password (i.e. password for input) of the user 100, which are included in the message received in S2008, to the OS 310 that has requested input of the OS user ID and password in S2002. Here, the processing branches depending on the OS login authentication form inputted in S2003. In the case where the form of local authentication is designated, the processing moves to S2015. In this case, the authentication server apparatus 130 does not need to exist. On the other hand, in the case where the form of authentication performed in domain is designated, the processing moves to S2010. In this case, it is necessary that the authentication server apparatus 130 exists (S2009).

The OS 310 of the user apparatus 110 sends the OS user ID and the input password of the user 100, which was acquired in S2009, to the authentication server apparatus 130 (S2010, S804).

The authentication program 520 of the authentication server apparatus 130 receives the OS user ID and the input password of the user 100, which are sent in S2010 (S2011, S804).

The authentication program 520 of the authentication server apparatus 130 performs authentication by using the OS user ID and the input password of the user 100, which were received in S2011, and the OS user ID and OS comparison password (i.e. comparison password for OS use) in the OS user information 340 recorded previously in the authentication server apparatus 130, to examine whether the user is one who can be permitted to log in (S2012).

The authentication program 520 of the authentication server apparatus 130 sends the result of the authentication in S2012 to the user apparatus 110 (S2013, S805).

The OS 310 of the user apparatus 110 receives the authentication result sent in S2013 (S2014, S805).

In the case where the form of local authentication is designated in S2009, the OS 310 of the user apparatus 110 performs authentication by using the OS user ID and the input password of the user 100, which were acquired in S2009, and the OS user ID and the OS comparison password in the OS user information 340 recorded previously in the user apparatus 110, to examine whether the user is one who can be permitted to log in. Next, if the authentication result acquired in this step (in the case of the form of local authentication) or in S2014 (in the case of the form of authentication performed in domain) indicates failure, the failure of authentication is displayed to the user 100, and the processing returns to S202. On the other hand, if the authentication result is successful, processing of permitting login to the OS is started, and the processing moves to S2016 (S2015).

Following the permission of login to the OS 310 in S2015, the high-level authentication client program 330 of the user apparatus 110 sends a message for changing the authentication status to “authenticated” to the high-level authentication server apparatus 140. This message includes the session ID held in S2008, so that it can be known that the message aims to change the authentication status of the user authenticated in S2006 (S2016, S905).

The high-level authentication server program 620 of the high-level authentication server apparatus 140 receives the message sent in S2016 to the effect that the authentication status is to be changed (S2017, S905).

The high-level authentication server program 620 of the high-level authentication server apparatus 140 compares the session ID included in the message (which was received in S2017) to the effect that the authentication status is to be changed with the session ID held in S2007. If coincident session IDs exist, the authentication status of the user associated with the session in question is changed into “authenticated”. If no coincident session ID exists, no authentication status is changed. In the case where the status is changed into “authenticated”, the execution date of this step is held as the last update date of the authenticated status. When a predetermined time elapses from the last update date, the high-level authentication server program 620 automatically changes the authentication status into “unauthenticated” (S2018).

The high-level authentication server program 620 of the high-level authentication server apparatus 140 sends the change result of the authentication status in S2018 to the user apparatus 110 (S2019, S906).

The high-level authentication client program 330 of the user apparatus 110 receives the authentication status change result sent in S2019 (S2020, S906).

Following the permission of login in S2015, the OS 310 of the user apparatus 110 displays a post-login-processing screen to the user 100 (S806). This step may be performed independently of the processing from S2016 through S2020, or may be performed after S2020.

Thus, the login processing to the OS 310 of the user apparatus 110 is finished.

Next, the processing of accessing to the AP 420 of the application server apparatus 120 will be described referring to FIG. 12.

In FIG. 12, the user apparatus 110 activates the application utilization program 320 when the user 100 performs execution operation of the application utilization program 320 (S3001, S807).

The application utilization program 320 of the user apparatus 110 sends a message for requesting access to the application server apparatus 120 in order to use the AP 420 in the application server apparatus 120. This message includes an identifier indicating which AP is to be used (S3002, S808).

The high-level authentication agent program 430 of the application server apparatus 120 receives the access request sent in S3002 (S3003, S808).

In response to the access request received in S3002, the high-level authentication agent program 430 of the application server apparatus 120 sends a message for requesting high-level authentication to the user apparatus 110 that has sent the access request (S304, S907).

The application utilization program 320 or the high-level authentication client program 330 of the user apparatus 110 receives the high-level authentication information requesting message sent in S3004. Depending on the employed method of high-level authentication, the application utilization program 320 receives the message if the application utilization program 320 can receive it as it is. Otherwise, the high-level authentication client program 330 receives the message (S3005, S907).

In the case where the application utilization program 320 receives the high-level authentication information request in S3005, the high-level authentication client program 330 of the user apparatus 110 detects that the high-level authentication information is requested, on the basis of characteristics of the screen of the application utilization program 320 or the state of using Application Programming Interface (API), for example.

It is assumed that the characteristics of the screen of the application utilization program 320 and the state of using API at the time the high-level authentication information is requested are previously recorded in the high-level authentication client program 330, being associated with the AP user ID of the AP as the target of access. These pieces of information are used for the above-mentioned detection.

Then, the high-level authentication information held in S2003 or new high-level authentication information recalculated using the high-level authentication information in question for authentication by the high-level authentication agent program 430 and the AP user ID required for using the AP 420 are sent to the application server apparatus 120 through the interface of the application utilization program 320.

On the other hand, in the case where the high-level authentication client program 330 receives the high-level authentication information request in S3005, the high-level authentication information held in S2003 or the new high-level authentication information recalculated using the high-level authentication information in question for authentication by the high-level authentication agent program 430 and the AP user ID required for using the AP 420 are automatically sent by the high-level authentication client program 330 of the user apparatus 110 to the application server apparatus 120 in response to the high-level authentication information request received in S3005 (S3006, S908).

The high-level authentication agent program 430 of the application server apparatus 120 receives the AP user ID and the high-level authentication information sent in S3006 (S3007, S908).

The high-level authentication agent program 430 of the application server apparatus 120 sends a message including the high-level authentication information received in S3007 to the high-level authentication server apparatus 140. The message includes an identifier that indicates authentication of AP access, so that it can be distinguished from authentication at the time of login to OS (S3008, S909).

The high-level authentication server program 620 of the high-level authentication server apparatus 140 receives the message that is sent in S3008 and includes the high-level authentication information (S3009, S909).

The high-level authentication server program 620 of the high-level authentication server apparatus 140 performs authentication of the user by using the high-level authentication information received in S3009 and the comparison high-level authentication information included in the high-level authentication server user information 630 in the high-level authentication server apparatus 130 (S3010).

Since the message received in S3009 includes the identifier that indicates authentication for AP access, the high-level authentication server program 620 of the high-level authentication server apparatus 140 examines whether the authentication status of the user, which is held in the high-level authentication server apparatus 140, is “authenticated”, in addition to the processing of S3010. In the case where the authentication status of the user is not “authenticated”, there is a possibility that the access bypassed the high-level authentication at the time of login to the OS, and thus the authentication fails. Further, in the case where the authentication of the high-level authentication information is successful and the authentication status is “authenticated”, the last update date of the authenticated status is updated to the execution date of this step (S3011).

Following the result of the authentication in S3010 and S3011, the high-level authentication server program 620 of the high-level authentication server apparatus 140 sends a message including the authentication result to the application server apparatus 120. In the case where the authentication of the user is successful, the message includes the input password of the user, which is recorded as the high-level authentication server user information 630 (S3012, S910).

The high-level authentication agent program 430 of the application server apparatus 120 receives the message (sent in S3011) including the authentication result. If the authentication result received in this step indicates failure, the high-level authentication agent program 430 of the application server apparatus 120 sends a message to the effect that the authentication has ended in failure to the user apparatus 110. The user apparatus 110 displays the failure of the authentication to the user 100, and suspends the processing. On the other hand, if the authentication is successful, the high-level authentication agent program 430 of the application server apparatus 120 delivers the AP user ID received in S3007 and the input password received in S3012 to the AP 420 of the application server apparatus 120 (S3013, S910).

The AP 420 of the application server apparatus 120 performs authentication by using the AP user ID (i.e. user ID for AP) and the input password received in S3013 and the AP user ID and the AP comparison password (i.e. comparison password for AP use) included in the AP user information 440 recorded in the application server apparatus 120, to examine whether the user is one who can be permitted to access the AP 420 (S3014).

The AP 420 of the application server apparatus 120 generates post-authentication-processing screen data based on the authentication result of S3014 or a response message according to specifications of the AP, and sends the data or the message to the user apparatus 110 that has made the access request in S3002. The data or the message in question includes an ID that is generated by random numbers or the like to indicate that the authentication of the AP 420 has finished. For example, it is information indicating the session's identifier that can be delivered as a Cookie (S3015, S813).

The application utilization program 320 of the user apparatus 110 receives the post-authentication-processing screen data or the response message sent in S3015 (S3016, S813).

Based on the data or message received in S3016, the application utilization program 320 of the user apparatus 110 displays a screen to the user if needed. For accessing the AP after this step, authentication at the time of AP access can be omitted by presenting again the ID indicating the finish of AP authentication to the application server apparatus 120 (S3017, S814).

Thus, the access processing of the AP 420 of the application server apparatus 120 is finished. In the case where a plurality of APs exist, the second- and later-accessed AP become available without authentication operation, by repeating the procedure of FIG. 12.

As described above, the present embodiment introduces the high-level authentication client program 330, the high-level authentication agent program 430 and the high-level authentication server apparatus 140 as additional components to the existing system. According to this arrangement, it is possible to migrate to high-level authentication when the processing described referring to FIGS. 11 and 12 is performed without altering the application utilization program 320, the AP 420, and the like. Thus, the introduction is very easy.

Further, since the authentication method is strengthened to become high-level one, higher security can be realized in comparison with a method using password even if login authentication of an OS is bypassed.

Further, by employing single sign-on that covers login to OS and authentication of access to each AP, a plurality of APs become available to a user through login to an OS if the user performs authentication operation only once.

The single sign-on can be realized safely, since an input password is not recorded in the user apparatus 110, the application server apparatus 120 and the authentication server apparatus 130. Further, a comparison password is recorded as a hash value or an encrypted value. Thus, when this method is combined with the method shown in FIG. 13, it becomes difficult to conjecture the input password even if the comparison password is accessed by an illegal person.

FIG. 13 shows details of the processing flow shown in FIG. 10 for updating a password managed by each apparatus of the present embodiment. The flow of FIG. 13 is performed independently of the processing flow shown in FIGS. 11 and 12. Further, it is assumed that the password management setting information 740 and the user ID relational information 750 are previously set in the password management server apparatus 150.

In FIG. 13, the password management program 720 of the password management server apparatus 150 starts a series of processes concerning password update at the time when a predetermined time has elapsed from the last date of password update processing, or when the administrator in charge of the password management program 720 performs operation of requesting password update through the interface for updating a password manually.

In the case where the processing is started when the predetermined time has elapsed, or in other words, where the subject of the password updating is the password management program 720, the processing moves to S4002. On the other hand, in the case where the administrator updates the password manually, the processing moves to S4003. The manual update of password by the administrator can be employed in an emergency such as the case where passwords recorded in respective systems become inconsistent, for example (S4001).

When the password update processing is started in S4001, the password management program 720 of the password management server apparatus 150 generates a password by random numbers or the like. Here, a password is generated for each user. Thus, in the case where there is a plurality of users whose passwords are to be updated, the number of generated passwords corresponds to the number of users.

Further, the generated password is one that satisfies the conditions set in the password policy included in the password management setting information. When this password policy is made stringent, it is possible to set a complex password that can not be remembered. Thus, conjecture of the password becomes more difficult in comparison with ordinary operation, and the security of password authentication can be improved. When automatic generation of the required number of passwords has been finished, the processing moves to S4005 (S4002).

In the case where the password update processing is started manually in S4001, the password management program 720 of the password management server apparatus 150 displays a password input screen to the administrator in order to request the password value that he desires to reset (S4003).

The password management program 720 of the password management server apparatus 150 acquires the password value inputted by the administrator following S4003 (S4004).

The password management program 720 of the password management server apparatus 150 reads the objects that should be subjected to password update. The password update objects are systems that use the user ID included in the user ID relational information 750 recorded in the password management server apparatus 150. In the present embodiment, passwords to be updated are the OS comparison password, the comparison password for each AP, the input password stored in the high-level authentication server apparatus (S4005).

The password management program 720 of the password management server apparatus 150 selects one apparatus for which password update has not been performed among the apparatuses as the password update objects read in S4005, and sends an access request for updating password to the password update object apparatus (S4006, S1001).

A password update program of the password update object apparatus receives the access request sent in S4006. This password update program has an interface through which update of password can be performed. In the present embodiment, the OS 310, the AP 420, the authentication program 520 and the high-level authentication server program 620 correspond to the password update program. Further, as for the OS 310, the AP 420 and the authentication program 520, it is assumed that each has an interface through which password can be updated, as a function before application of the present embodiment (S4007, S1001).

In response to the access request received in S4007, the password update program of the password update object apparatus sends a message requesting authentication information to the password management server apparatus 150 (S4008, S1002).

The password management program 720 of the password management server 150 receives the message (sent in S4008) that requests authentication information (S4009, S1002).

The password management program 720 of the password management server apparatus 150 sends the administrator authentication information corresponding to the authentication information request received in S4009 to the password update object apparatus. In the case where the subject of the password updating is the program, the corresponding administrators authentication information is acquired from the object system's administrator authentication information included the password management setting information 740 of the password management server apparatus 150, and the acquired administrator authentication information is sent automatically. On the other hand, in the case where the subject of the password updating is the administrator, a screen requesting input of the authentication information is displayed to the administrator, and the authentication information inputted by the administrator is sent to the password update object apparatus (S4010, S1003).

The password update program of the password update object apparatus receives the administrator authentication information sent in S4010 (S4011, S1003).

The password update program of the password update object apparatus performs authentication by using the administrator authentication information received in S4011, to examine whether the administrator has authority to update the password (S4012).

The password update program of the password update object apparatus sends a message including the result of the authentication in S4012 to the password management server apparatus 150 (S4013, S1004).

The password management program 720 of the password management server apparatus 150 receives the message (sent in S403) that includes the authentication result. In the case where the received authentication result indicates failure and the subject of password updating is the program, the processing is suspended here. In the case where the received authentication result indicates failure and the subject of password updating is the administrator, a screen is displayed to show that the authentication has ended in failure, and the processing returns to S4010. On the other hand, in the case where the authentication result is successful, the processing moves to S4015 (S4014, S1004).

The password management program 720 of the password management server apparatus 150 sends the user ID corresponding to the password update object apparatus of the user whose password is to be updated and the password generated automatically in S4002 or acquired in S4004 to the password update object apparatus. The corresponding user ID is acquired from the user ID relational information 750 recorded in the password management server apparatus 150 in question (S4015, S1005).

The password update program of the password update object apparatus receives the user ID and password sent in S4015 (S4016, S1005).

The password update program of the password update object apparatus updates the password managed in the apparatus by using the user ID and password received in S4016 (S4017).

The password update program of the password update object apparatus sends a message that includes the result of the password update in S4017 to the password management server apparatus 150 (S4018, S1006).

The password management program 720 of the password management server apparatus 150 receives the message including the password update result sent in S4018 (S4019, S1006).

The password management program 720 of the password management server apparatus 150 examines existence of an object for which update has not been performed among the apparatuses as the password update objects. If there is an object for which password update has not been performed, the processing moves to S4005. On the other hand, if the update has been finished for all the objects, the password update processing is finished here (S4020).

In the case where user IDs and passwords of a plurality of users are to be updated, any of the following methods can be employed: a method in which information corresponding to a plurality of users is sent at once in S4015; a method in which the processes from S4015 through S4019 are repeated the number of times corresponding to the number of users; and a method in which the processes from S4001 through S4020 are repeated the number of times corresponding to the number of users.

Thus, the processing of updating password managed by each apparatus of the present embodiment has been finished.

By realizing the processing flow and components described referring to FIG. 13, it is possible to migrate to high-level authentication by introducing the password management server apparatus 150, the high-level authentication client program 330, the high-level authentication agent program 430, the high-level authentication server apparatus 140 and the password management server apparatus 150 as additional components without altering the application utilization program 320, the AP 420 and the like used in the existing system. Thus, the introduction is very easy.

Further, it is possible to improve resistance to illegal access even when it directly accesses a program that uses the password authentication existing before the application of the present embodiment while bypassing the authentication function of the programs added in the embodiment of FIGS. 11 and 12 for strengthening the authentication method. Also, as for the high-level authentication server apparatus that needs constant record of password, the password is periodically updated to one that even the user of the password does not know. Thus, it is possible to keep the security. Further, it is possible to reduce the data size required for password management, when a password for OS and a password for each AP are made common.

Thus, by realizing the processing flows and components of FIGS. 11, 12 and 13, it is possible to satisfy three requirements: i.e. improvements in easiness of introduction, security, and convenience.

The specification and drawings are, accordingly, to be regarded in an illustrative rather than a restrictive sense. It will, however, be evident that various modifications and changes may be made thereto without departing from the spirit and scope of the invention as set forth in the claims.

We claim:

1. An authentication system comprising a user apparatus that performs authentication processing using first authentication data and a second authentication server apparatus that performs authentication processing using second authentication data, wherein:
the user apparatus:
acquires the second authentication data from a user; and
requests authentication of the user by sending the acquired second authentication data to the second authentication server apparatus;
the second authentication server:
performs authentication processing of the user on a basis of the second authentication data received from the user apparatus; and
sends the user apparatus a result of the authentication processing and, when the authentication is successful, first authentication data stored being associated with the user;
the user apparatus:
acquires a result of authentication processing based on the first authentication data received from the second authentication server apparatus; and
performs login processing when the acquired result of the authentication processing based on the first authentication data indicates success.

2. An authentication system of claim 1, wherein:
the authentication system further comprises an application server apparatus;
the user apparatus:
stores the second authentication data acquired from the user;
sends the result of the authentication processing based on the first authentication data received from the second authentication server apparatus; and
receives a use request for using the application server apparatus from the user after the login processing, and sends the received use request to the application server apparatus;
the second authentication server apparatus:
receives the result of the authentication processing result based on the first authentication data sent to the user apparatus, from the user apparatus;
the application server apparatus:
sends an authentication processing request based on the use request received from the user apparatus to the user apparatus;
the user apparatus:
sends the stored second authentication data of the user to the application server apparatus in response to the authentication processing request received from the application server apparatus;
the application server apparatus:
sends the second authentication data received from the user apparatus to the second authentication server apparatus, to request authentication of the user;
the second authentication server:
performs authentication processing on a basis of the second authentication data received from the application server apparatus when the authentication processing result received from the user apparatus is successful; and
sends the first authentication data stored being associated with the user to the application server apparatus, when the authentication processing is successful; and
the application server apparatus:
performs authentication processing of the user on a basis of the first authentication data received from the second authentication server apparatus.

3. An authentication system of claim 1, wherein:
the user apparatus:
performs authentication processing on a basis of the first authentication data received from the second authentication server apparatus; and
acquires a result of the authentication processing.

4. An authentication system of claim 1, wherein:
the authentication system further comprises a first authentication server apparatus that performs authentication processing on a basis of the first authentication data;
the user apparatus:
sends the first authentication data received from the second authentication server apparatus to the first authentication server apparatus;
the first authentication server apparatus:
performs the authentication processing of the user on a basis of the first authentication data received from the user apparatus; and
sends a result of the authentication processing to the user apparatus; and
the user apparatus:
acquires the result of the authentication processing.

5. An authentication system of claim 1, wherein:
the first authentication data is a password, and the second authentication data is biometric data.

6. A user apparatus that is used in an authentication system and performs authentication processing on a basis of first authentication data, wherein the user apparatus:
acquires second authentication data different from the first authentication data from a user;
sends the acquired second authentication data to a second authentication server apparatus, to request authentication of the user;
receives the first authentication associated with the user, as a result of success of the requested authentication from the second authentication server; and
performs login processing when a result of authentication processing based on the received first authentication data is successful.

7. A user apparatus of claim 6, wherein the user apparatus:
performs authentication processing based on the first authentication data received from the second authentication server apparatus; and
acquires a result of the authentication processing based on the first authentication processing.

8. A user apparatus of claim 6, wherein:
the authentication system further comprises a first authentication server apparatus that performs authentication processing based on the first authentication data;
the user apparatus sends the first authentication data received from the second authentication server apparatus to the first authentication server apparatus that performs authentication processing based on the first authentication data; and
the user apparatus acquires a result of the authentication processing based on the sent first authentication data from the first authentication server apparatus.

9. An authentication server apparatus used in an authentication system, wherein the authentication server apparatus:
stores first authentication data associated with a user;
receives second authentication data inputted by the user from a user apparatus;
performs authentication processing based on the second authentication data;
sends the user the first authentication data stored being associated with the user, when the authentication processing is successful; and
receives a result of authentication processing based on the sent first authentication data from the user apparatus.

10. An authentication server apparatus of claim 9, wherein:
when the result of the authentication processing based on the first authentication data, which is received from the user apparatus, indicates success, and the authentication server apparatus receives an authentication request accompanied by the second authentication data of the user from another apparatus, the authentication server apparatus performs authentication processing based on the second authentication data; and
when the authentication processing is successful, the authentication server apparatus sends the first authentication data stored being associated with the user to the another apparatus.

11. An application server apparatus that performs authentication processing based on first authentication data, wherein:
when the application server apparatus receives a use request and second authentication data different from the first authentication data from a user apparatus, the application server apparatus sends the second authentication data to an authentication server apparatus, to request authentication of a user;
the application server apparatus receives the first authentication data associated with the user as a result that the request authentication is successful, from the authentication server apparatus;
the application server apparatus performs authentication processing based on the received first authentication data; and
when the authentication processing is successful, the application server apparatus accepts the use request.
